(19) United States
(12) Patent Application Publication
(10) Pub. No.: US 2018/0023550 A1
(43) Pub. Date: Jan. 25, 2018

(54) IODINE PROPELLANT RF ION THRUSTER WITH RF CATHODE

(71) Applicant: Busek Co., Inc., Natick, MA (US)

(72) Inventors: Michael Tsay, N. Chelmsford, MA (US); John J. Frongillo, III, Winchester, MA (US); Joshua Model, Lexington, MA (US); Jurg Zwahlen, New Ipswich, NH (US)

(73) Assignee: Busek Co., Inc.

(21) Appl. No.: 15/425,317

(22) Filed: Feb. 6, 2017

Related U.S. Application Data
(60) Provisional application No. 62/319,550, filed on Apr. 7, 2016.

(51) Int. Cl. F03H 1/00

(52) U.S. Cl. CPC F03H 1/0031; F03H 1/0043; F03H 1/0012

(57) ABSTRACT

A thrust producing system includes an RF ion thruster with a discharge chamber having a gas inlet and an outlet, and a coil about the discharge chamber. The system further includes an RF cathode proximate the discharge chamber outlet of the RF ion thruster for ion beam neutralization. The RF cathode includes a discharge chamber having a gas inlet and an outlet and a coil about the discharge chamber. A tank for containing iodine in solid form and a heater associated with said tank to produce iodine vapor. A feed subsystem fluidly couples the tank with the RF ion thruster discharge chamber gas inlet and with the RF cathode discharge chamber gas inlet.

### RELATED APPLICATIONS

This application claims benefit of and priority to U.S. Provisional Application Ser. No. 62/319,550 filed Apr. 7, 2016, under 35 U.S.C. §§119, 120, 363, 365, and 37 C.F.R. §1.55 and §1.78, which is incorporated herein by this reference.

### GOVERNMENT RIGHTS

This invention was made with U.S. Government support under Contract No. NNX15CC90C awarded by the National Aeronautics and Space Administration (NASA). The Government may have certain rights in the subject invention.

### FIELD OF THE INVENTION

The subject invention relates to radio frequency ion thrusters.

### BACKGROUND OF THE INVENTION

Radio frequency ion thrusters typically operate on a propellant such as xenon and include a hollow cathode to neutralize the ion beam emitted by the discharge chamber of the ion generator. See U.S. Pat. No. 9,060,412 incorporated herein by this reference.

The hollow cathode includes an oxide insert which is consumed when the cathode is operated limiting the life of the cathode. Also, a heater is required. A hollow cathode with a C12A7 electride insert is proposed in U.S. Published Application No. 2014/0354138 incorporated herein by this reference and purportedly a heater is not required. Still, in testing, a heater was required for proper operation and such a hollow cathode design may impart constraints for certain types of missions where power is limited or rapid start of the cathode is required.

Because of the difficulty to integrate high-pressure xenon gas vessels onboard small spacecraft, iodine has been proposed for use in electric propulsion devices such as RF ion thrusters. See U.S. Pat. No. 6,609,363 incorporated herein by this reference. Still, a hollow cathode was used as the neutralizer.

The notion of an RF neutralizer for an ion thruster has been studied. See T. Hatakeyama et al., “Preliminary Study on Radio Frequency Neutralizer for Ion Engine,” LEPC-2007-226 (2007) incorporated herein by this reference.

### BRIEF SUMMARY OF THE INVENTION

Until now, no known RF ion thruster using iodine as a propellant includes an RF cathode as the neutralizer that also uses iodine as a source of fuel. In the subject invention, both the RF ion thruster and the RF cathode are designed to use iodine in order to, respectively, create ions and neutralizing electrons. As a result, high pressure gas vessels are not required to operate the ion thruster or cathode.

Featured is a system comprising an RF ion thruster including a discharge chamber having a gas inlet and an outlet and a coil about the discharge chamber. An RF cathode is located proximate the discharge chamber outlet of the RF ion thruster and includes a discharge chamber having a gas inlet and an outlet and a coil about the discharge chamber. The system further includes a tank for containing iodine in solid form, a heater associated with said tank to produce iodine vapor, and a feed subsystem fluidly coupling said tank with the RF ion thruster discharge chamber gas inlet and also with the RF cathode discharge chamber gas inlet.

The system further may include an igniter associated with the RF cathode discharge chamber inlet and, in one example, an igniter associated with the RF ion thruster discharge chamber inlet. The RF cathode discharge chamber inlet may include a conduit and the igniter includes spaced conductive electrodes in the conduit coupled to a voltage source and a voltage bias source.

The RF ion thruster may include a conductive grid subsystem proximate the RF ion thruster discharge chamber outlet. In one example, the conductive grid subsystem of the RF ion thruster includes at least two conductive plates with orifices therethough, one said plate supplied with a positive voltage and the other said plate supplied with a negative voltage.

Preferably, the RF cathode includes an electron extractor proximate the RF cathode discharge chamber outlet. In one example, the electron extractor includes a conductive grid subsystem with at least one conductive plate with orifices therethough and a plurality of rearwardly extending members received at least partially in the RF cathode discharge chamber to increase the electron output of the RF cathode. In another example, the electron extractor includes a ring internal to the RF cathode discharge chamber. One preferred ring includes spaced fingers extending therefrom. Further included may be an orifice plate at the RF cathode discharge chamber outlet.

Preferably, the RF ion thruster, the RF cathode, the tank, and the feed subsystem are made of materials resistant to iodine. In one example, the discharge chamber of the RF ion thruster and the discharge chamber of the RE cathode are made of ceramic material. The tank may be made of thermoplastic and includes a metal internal coating to uniformly distribute heat. In one example, the heater includes tape heaters bonded to the coating. Also featured is a novel RF cathode system comprising a ceramic discharge chamber having a gas inlet and an outlet, a coil about the discharge chamber, a tank for containing iodine in solid form, a heater associated with said tank to produce iodine vapor, a feed subsystem fluidly coupling the tank with the RF cathode discharge chamber gas inlet, an igniter associated with the RF cathode discharge chamber inlet including spaced conductive electrodes coupled to a voltage source and a voltage bias source, and an electron extractor proximate the discharge chamber outlet.

Also featured is a method of generating thrust. Iodine is headed to produce iodine vapor. The iodine vapor is fed to an RF ion thruster to produce an ion beam which is neutralized by feeding iodine vapor to an RF cathode producing electrons directed to the ion beam output by the RF ion thruster.

The method may further include increasing the electron output of the RF cathode by placing at least one grid plate proximate the RF cathode and increasing the surface area of the grid plate. There may be two conductive plates with orifices therethough, one plate supplied with a positive voltage and the other plate supplied with a negative voltage.

The method may further include generating seed electrons drawn into the RF cathode. In one example, generating seed electrons includes locating an igniter upstream of the RF cathode. In some embodiments, the method may further include generating seed electrons drawn into the RF ion thruster by locating an igniter upstream of the RF ion thruster.

The method may further include extracting electrons from the RF cathode. In one example, extracting electrons includes placing a ring with fingers extending therefrom inside the RF cathode.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a highly schematic view of an example of an RF ion thruster system in accordance with the invention;

FIG. 2 is a schematic view of a conductive grid plate for the RF cathode shown in FIG. 1;

FIG. 3 is a schematic view showing an example of an igniter for the RF cathode shown in FIG. 1;

FIG. 4 is a schematic view of an example of another RF cathode useful in connection with the system of FIG. 1;

FIG. 5 is a cross sectional view of the RF cathode of FIG. 4;

FIG. 6 is a schematic three dimensional cut away view of an example of an iodine storage tank shown in FIG. 1; and

FIG. 7 is a schematic three dimensional partially cut away view showing another example of an iodine storage tank.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

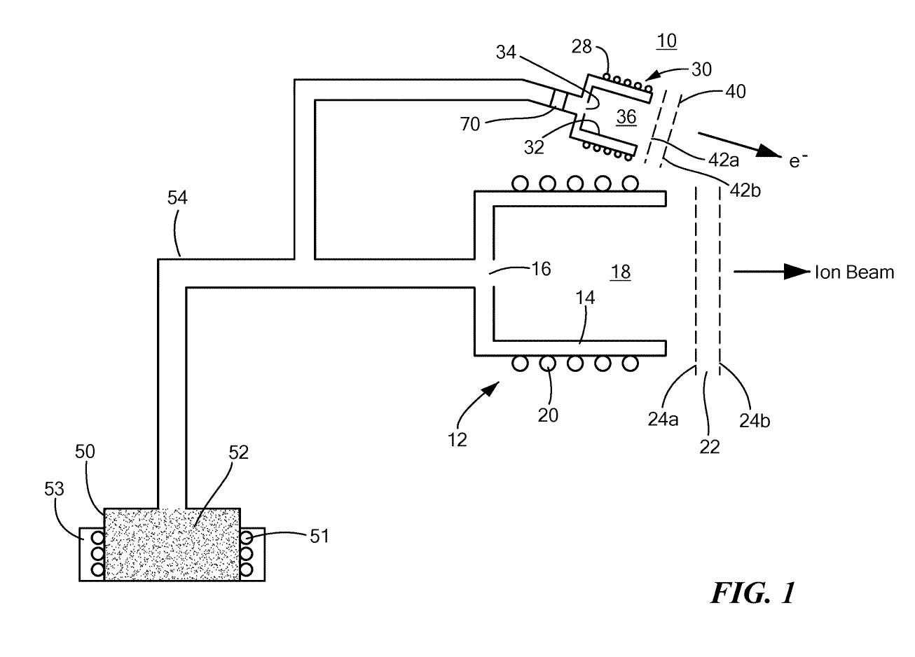

FIG. 1 shows an exemplary RF ion thruster system 10 with RF ion thruster 12 including ceramic discharge chamber 14 having a gas inlet 16 and an outlet 18. Coil 20 is disposed about chamber 14 and conductive grid subsystem 22 proximate discharge chamber outlet 18 typically includes conductive plates 24a, 24b with orifices therethrough. In operation, plate 24a may be supplied with a positive voltage (e.g., 1.5-2.5 kV) and plate 24b may be supplied with a negative voltage (e.g., −100 to −200 V).

RF cathode 30 is disposed proximate the discharge chamber outlet 18 of RF ion thruster 12. Cathode or neutralizer 30 includes ceramic discharge chamber 32 with gas inlet 34 and outlet 36. Coil 28 is disposed about discharge chamber 32. A conductive grid subsystem 40 disposed at the outlet 36 may include a conductive plate 42a and optional conductive plate 42b both including orifices therethrough. Plate 42a may be supplied with a negative voltage (e.g., −50 to −200 V) and plate 42b if used is typically at reference potential, 0 volts.

The ceramic material of the discharge chambers 14 and 32 is preferably highly resistant to iodine. In one example, the ceramic material used was alumina. In another example, the ceramic material was Macor. The RF coils 20 and 38 are preferably made of highly conductive material with extremely thin insulation layer for maximum inductance at a 1-10 MHz frequency range. In one example the coil was made of pure silver wire with 0.005″-thick PTFE tubing. In another example the coil was made of pure silver wire with 0.001″-thick polyamide tape or coating for insulation.

Tank 50 stores solid iodine 52 therein (e.g., powder, a solid block of iodine, iodine chips, or the like). Heater 51 associated with tank 50 is used to heat the solid iodine and produce iodine vapor supplied by feed subsystem 54 to the inlet 16 of ion thruster 12 and to the inlet 34 of cathode 30. Tank 50 may be formed from a machined polyetherimide (PEI, trade name Ultem) box with an epoxied or ultrasonically-welded Ultem lid, or a stamp formed thin Hastelloy or Inconel sheet with a welded lid, or a fully welded box made of thin Hastelloy or Inconel sheets. Heater 51 is bonded to the tank exterior and an outer layer of insulation 53 may be included. The heater 51 may also be bonded to the tank 50 interior, with or without additional outer layer of insulation 53.

The various valves, sensors, heaters, and controls associated with a feed system fluidly connecting the tank 50 with the ion thruster and the cathode are not shown in FIG. 1. But, aspects of the propellant management subsystem of U.S. Pat. No. 8,610,356, incorporated herein by this reference, may be used. Also, aspects of the vapor distribution subsystem disclosed in U.S. Provisional Patent Application No. 62/259,779 incorporated herein by this reference, may be used. The various conduits used may be PTFE, PFA, Nylon, Hastelloy or Inconel, or silica-coated metal gas lines.

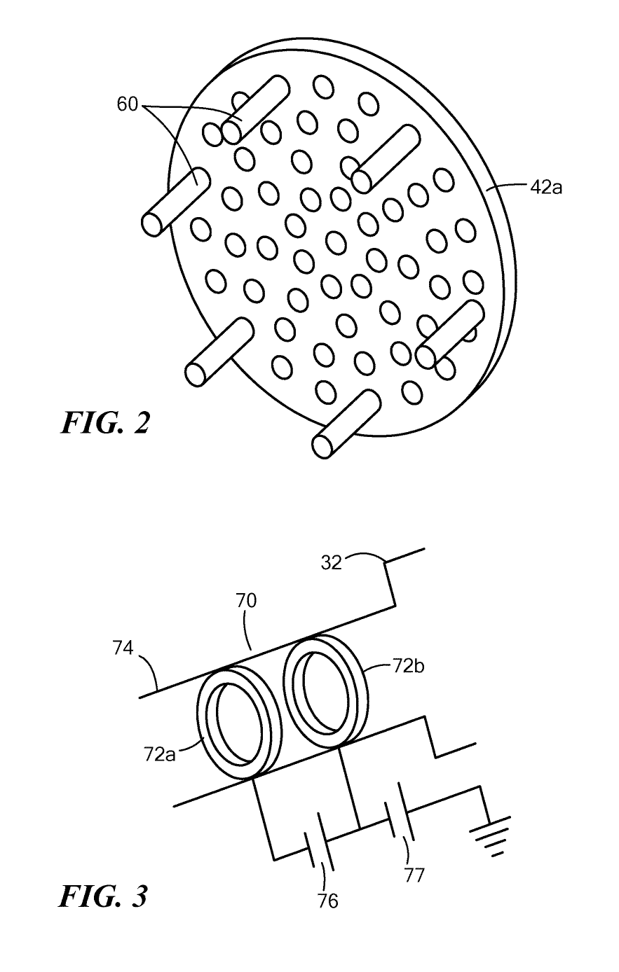

Preferably, conductive grid plate 42a of the cathode, FIG. 2 includes rearwardly extending members such as posts 60 proximate the periphery of plate 42a and extending at least partially into chamber 32, FIG. 1 to increase the electron output of RF cathode 30 by increasing the corresponding ion collection surface area.

Also, an igniter 70, FIG. 1 is preferably associated with RF cathode 30 discharge chamber inlet 34. In one example, the igniter 70, FIG. 3 includes two spaced conductive ring electrodes 72a, 72b inside inlet conduit 74 coupled to a voltage source 76 and a bias voltage source 77 relative to reference potential at 0 Volts. The voltage source 76 can be either DC or AC powered and its main function is to create a pilot discharge that generates seed electrons, which are then drawn into the cathode's discharge chamber 32 to ignite the plasma in the RF cathode 30. The electrodes represented by 72a and 72b, FIG. 3, in another example were made of a wire spaced from a metal gas fitting. The said igniter 70 can also be incorporated into the RF ion thruster 12 at the discharge chamber gas inlet 16 with the same voltage sources 76 and 77.

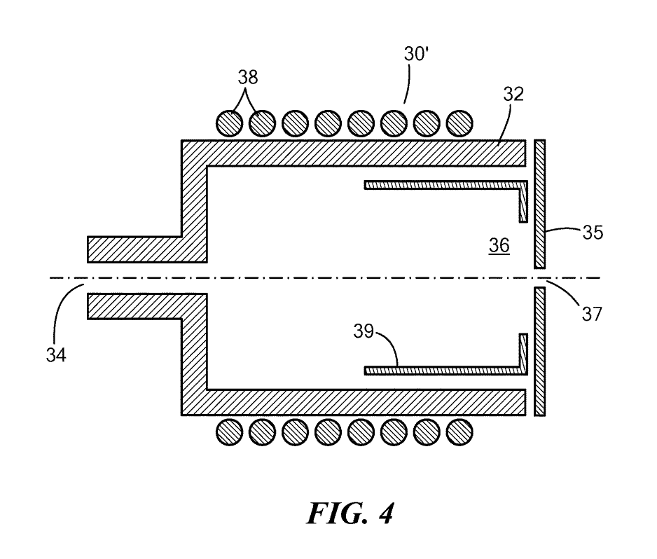

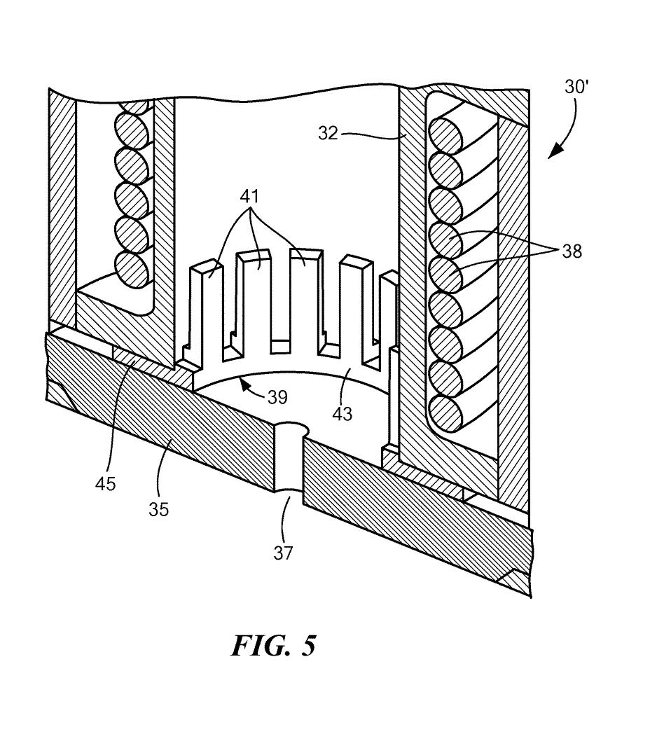

Because of the corrosiveness of iodine, any component in the system exposed to iodine is preferably made of materials resistant to iodine. Thus, the interior of tank 50, the interior of the conduits of the feed subsystem 54, the interior of chambers 14 and 32, the plates of the conductive grid subsystems 22 and 40, the electron extractor 39, FIGS. 4-5, and the igniter electrodes are made of materials resistant to iodine. In one example, all the gridded plates were made of molybdenum. Other suitable iodine resistant materials and coatings includes certain plastics such as Ultem, PEEK, or the like, certain metals such as gold, Hastelloy, Inconel, tungsten, platinum, nickel, nickel sulfamate, molybdenum, MolRe alloys, ceramics or glass such Alumina, Macor, silica and even ruby or sapphire materials.

Another example of an RF cathode 30′ is shown in FIGS. 4-5. The RF cathode shown in FIG. 1 employs active electron extraction because the two grid plates 42a and 42b urge electrons out of the discharge chamber. RF cathode 30′, FIGS. 4-5, in contrast, employs passive electron extraction because it relies on the positively charged plume generated by RF thruster 12, FIG. 1 to withdraw electrons from the RF cathode discharge chamber to achieve neutralization. Power is saved because only one cathode grid is required.

The RF cathode of FIGS. 4-5 features ceramic orifice plate 35 at outlet of the RF cathode discharge chamber. The orifice 37 is shown in FIGS. 4-5. RF cathode 30′ also features negatively biased internal grid electrode 39 (i.e. an ion collection electrode). Electrode 39 preferably includes spaced fingers 41 extending from ring portion 43 which may include flange 45 disposed between the end of chamber 32 and the inside of orifice plate 35. Thus, the ring portion 43 and the fingers 41 abut the interior of the chamber 32. The fingers extend readwardly in the chamber. The ring and fingers may be made of Hastelloy, Inconel, Stainless Steel, or Molybdenum.

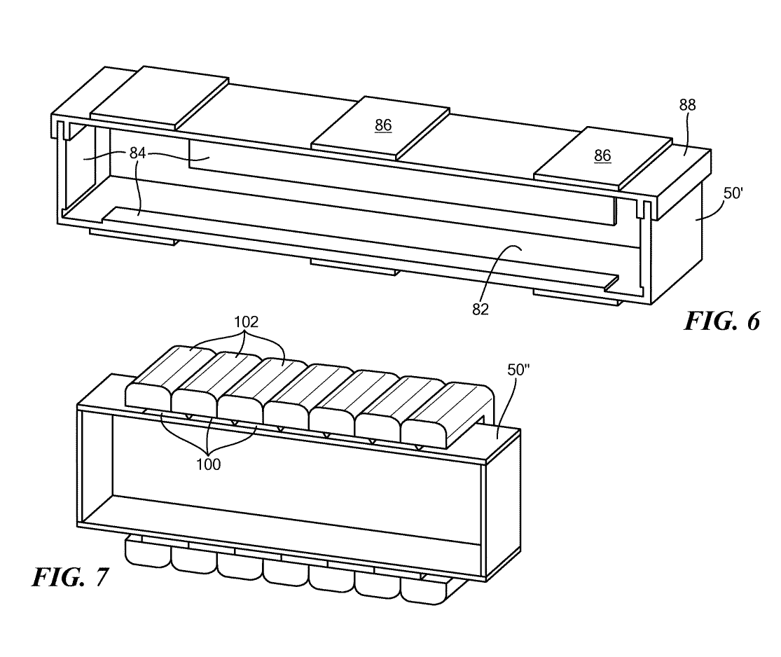

In one example, iodine tank 50′, FIG. 6 is made of a plastic material 80 (e.g., Ultem) internally coated with a layer of gold or nickel 82 to uniformly distribute the heat supplied by tape style heaters 84 bonded to layer 82. The exterior of plastic tank 80 can be reinforced with a fiberglass coating, a carbon fiber wrap, or metal bands 86. Lid 88 is epoxied or ultrasonically welded to the tank.

In another example, tank 50″, FIG. 7 includes stamp-formed, fully welded, or 3-D-printed Hastelloy or Inconel tank, exterior heater 100, and thermal insulation layer 102.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. An RF ion thruster system comprising:
an RF ion thruster including:
a discharge chamber having a gas inlet and an outlet, and
a coil about the discharge chamber;
an RF cathode proximate the discharge chamber outlet of the RF ion thruster and including:
a discharge chamber having a gas inlet and an outlet, and
a coil about the discharge chamber;
a tank for containing iodine in solid form;
a heater associated with said tank to produce iodine vapor; and
a feed subsystem fluidly coupling said tank with the RF ion thruster discharge chamber gas inlet and with the RF cathode discharge chamber gas inlet.

2. The system of claim 1 further including an igniter associated with the RF cathode discharge chamber inlet and an optional igniter associated with the RF ion thruster discharge chamber inlet.

3. The system of claim 2 in which the RF cathode discharge chamber inlet includes a conduit and the igniter includes spaced conductive electrodes in the conduit coupled to a voltage source and a voltage bias source.

4. The system of claim 1 in which the RF ion thruster includes a conductive grid subsystem proximate the RF ion thruster discharge chamber outlet.

5. The system of claim 4 in which the conductive grid subsystem of the RF ion thruster includes at least two conductive plates with orifices therethrough, one said plate supplied with a positive voltage and the other said plate supplied with a negative voltage.

6. The system of claim 1 in which the RF cathode includes an electron extractor proximate the RE cathode discharge chamber outlet.

7. The system of claim 6 in which the electron extractor includes a conductive grid subsystem with at least one conductive plate with orifices therethrough and a plurality of rearwardly extending members received at least partially in the RF cathode discharge chamber to increase the electron output of the RF cathode.

8. They system of claim 6 in which the electron extractor includes a ring internal to the RF cathode discharge chamber, said ring including spaced fingers extending therefrom.

9. The system of claim 8 further including an orifice plate at the RF cathode discharge chamber outlet.

10. The system of claim 1 in which the RF ion thruster, the RF cathode, the tank, and the feed subsystem are made of materials resistant to iodine.

11. The system of claim 10 in which the discharge chamber of the RF ion thruster and the discharge chamber of the RF cathode are made of ceramic material.

12. The system of claim 10 in which the tank is made of thermoplastic and includes a metal internal coating to uniformly distribute heat.

13. The system of claim 12 in which the heater includes tape heaters bonded to the coating.

14. An RF cathode system comprising:
a ceramic discharge chamber having a gas inlet and an outlet;
a coil about the discharge chamber;
a tank for containing iodine in solid form;
a heater associated with said tank to produce iodine vapor;
a feed subsystem fluidly coupling said tank with the RF cathode discharge chamber gas inlet;
an igniter associated with the RF cathode discharge chamber inlet including spaced conductive electrodes coupled to a voltage source and a voltage bias source; and
an electron extractor proximate the discharge chamber outlet.

15. The system of claim 14 in which the extractor includes a conductive grid subsystem with at least one conductive plate with orifices therethrough and a plurality of rearwardly extending members received at least partially in the RF cathode discharge chamber to increase the electron output of the RF cathode.

16. They system of claim 14 in which the electron extractor includes a ring internal to the RF cathode discharge chamber, said ring including spaced fingers extending therefrom.

17. The system of claim 16 in which the electron extractor further includes an orifice plate at the RF cathode discharge chamber outlet.

18. The system of claim 14 in which the electron extractor, the tank, and the feed subsystem are made of materials resistant to iodine.

19. The system of claim 18 in which the tank is made of thermoplastic and includes a metal internal coating to uniformly distribute heat.

20. The system of claim 18 in which the heater includes tape heaters bonded to the coating.

21. A method of generating thrust, the method comprising:
heating iodine to produce iodine vapor;
feeding said iodine vapor to an RF ion thruster to produce an ion beam;
neutralizing said ion beam by feeding said iodine vapor to an RF cathode producing electrons directed to the ion beam output by the RF ion thruster.

22. The method of claim 21 further including increasing the electron output of the RF cathode by placing at least one grid plate proximate the RF cathode and increasing the surface area of the grid plate.

23. The method of claim 22 further including at least two conductive plates with orifices therethough, one said plate supplied with a positive voltage and the other said plate supplied with a negative voltage.

24. The method of claim 21 further including generating seed electrons drawn into the RF cathode.

25. The method of claim 24 in which generating seed electrons include locating an igniter upstream of the RF cathode.

26. The method of claim 21 further including generating seed electrons drawn into the RF ion thruster.

27. The method of claim 26 in which generating seed electrons drawn into the RF ion thruster includes locating an igniter upstream of the RF ion thruster.

28. The method of claim 21 further including extracting electrons from the RF cathode.

29. The method of claim 28 in which extracting electrons includes placing a ring with fingers extending therefrom inside the RF cathode.
